(19) United States
(12) Patent Application Publication
(10) Pub. No.: US 2014/0104429 A1
(43) Pub. Date: Apr. 17, 2014

(54) CORRECTIONAL FACILITY ACCESS AND SECURITY APPARATUS, SYSTEMS, AND METHODS

(71) Applicant: ARGYLE SECURITY, INC., (US)

(72) Inventors: Jeffrey D. Ward, New Braunfels, TX (US); Mark S. McDonald, San Antonio, TX (US)

(73) Assignee: ARGYLE SECURITY, INC., San Antonio, TX (US)

(21) Appl. No.: 13/834,585

(22) Filed: Mar. 15, 2013

Related U.S. Application Data
(60) Provisional application No. 61/671,497, filed on Jul. 13, 2012.

(51) Int. Cl. G07C 9/00

(52) U.S. Cl. CPC G07C 9/00079
USPC 348/156

(57) ABSTRACT

Correctional facility access and security apparatus, systems, and methods may include one or more access devices connected to one or more user devices via a network. The access devices and user devices may also be connected via the network with a computer, video recorder, and audio recorder. Each access device may be associated with an entry or exit point to a correctional facility and may send video and audio data to one or more of the user devices via the network showing activities in the vicinity of the access device. The entry or exit points may be remotely monitored using the video and audio data delivered to the user device and may be remotely controlled by users of the user devices.

### CROSS-REFERENCE TO RELATED APPLICATIONS

This application claims priority to U.S. Provisional Patent Application No. 61/671,497 filed Jul. 13, 2012, the disclosure of which is incorporated herein by reference.

### COPYRIGHT NOTICE

This application contains material that is subject to copyright protection. Such material may be reproduced exactly as it appears in Patent and Trademark Office patent files or records. The copyright owner otherwise reserves all rights to such material.

### FIELD

This application relates generally to the field of security for correctional facilities, and more specifically to apparatus, systems, and methods for monitoring and controlling access to, from, and within a correctional facility.

### BACKGROUND

In the field of monitoring and controlling access to correctional facilities, there is often a need to accurately monitor activities in the vicinity of access points to a correctional facility and activities at other secured locations within the correctional facility. There is a high cost associated with employing guards and other personnel at each access point and it is often impractical to personally monitor the movement of each person into and out of a correctional facility and within the correctional facility. In addition, guards and other personnel who are employed to monitor access points are often required to pass extensive background checks and receive other specialized training, such as self-defense and weapons training, which may be expensive and time consuming. It is often impractical to employ such a skilled workforce at each access point of a correctional facility during all hours of a day. Thus, there is a need for improved apparatus, systems and methods for securing and monitoring access points at a correctional facility which allows for monitoring and control of access points by a few skilled personnel who can monitor access points from mobile locations or fixed monitoring stations within or outside of the correctional facility.

### SUMMARY

Correctional facility access and security apparatus, systems and methods may include one or more access devices connected to one or more user devices via a network. The access devices and user devices may also be connected via the network with a computer, video recorder and audio recorder. Each access device may be associated with an entry or exit point to a correctional facility and may send video and audio data to one or more of the user devices via the network showing activities in the vicinity of the access device. The entry or exit points may be remotely monitored using the video and audio data delivered to the user device and may be remotely controlled by users of the user devices.

### BRIEF DESCRIPTION OF THE DRAWINGS

FIG. 1 is a schematic diagram of a correctional facility access and security system.

FIG. 2 is a schematic diagram of an access device.

FIG. 3 is a schematic diagram of a user device.

FIG. 4 is a schematic diagram of a correctional facility access and security method.

FIG. 5 is a schematic diagram of another correctional facility access and security method.

FIG. 6 is a schematic diagram of yet another correctional facility access and security method.

FIG. 7 is a schematic diagram of still another correctional facility access and security method.

### DETAILED DESCRIPTION

As used herein, the following terms should be understood to have the indicated meanings:

When an item is introduced by “a” or “an,” it should be understood to mean one or more of that item.

“Access point” means an entry point or exit point of a correctional facility. An access point may be both an entry point and an exit point. An access point may include but is not limited to a door or a gate. An access point may provide entry to and/or exit from an exterior location of a correctional facility or passage between or among two or more interior locations of a correctional facility.

“Communication” means the transmission of one or more signals from one point to another point. Communication between two objects may be direct, or it may be indirect through one or more intermediate objects. Communication in and among computers, I/O devices and network devices may be accomplished using a variety of protocols. Protocols may include, for example, signaling, error detection and correction, data formatting and address mapping. For example, protocols may be provided according to the seven-layer Open Systems Interconnection model (OSI model), the TCP/IP model, or any other suitable model.

“Comprises” means includes but is not limited to.

“Comprising” means including but not limited to.

“Computer” means any programmable machine capable of executing machine-readable instructions. A computer may include but is not limited to a general purpose computer, mainframe computer, microprocessor, computer server, digital signal processor, personal computer (PC), personal digital assistant (PDA), laptop computer, desktop computer, notebook computer, smartphone (such as Apple's iPhone™, Motorola's Atrix™ 4G, and Research In Motion's Blackberry™ devices, for example), tablet computer, netbook computer, portable computer, portable media player with network communication capabilities (such as Microsoft's Zune HD™ and Apple's iPod Touch™ devices, for example), camera with network communication capability, wearable computer, point of sale device, or a combination thereof. A computer may comprise one or more processors, which may comprise part of a single machine or multiple machines.

“Computer readable medium” means an article of manufacture having a capacity for storing one or more computer programs, one or more pieces of data, or a combination thereof. A computer readable medium may include but is not limited to a computer memory, hard disk, memory stick, magnetic tape, floppy disk, optical disk (such as a CD or DVD), zip drive, or combination thereof.

“Correctional facility” means a jail, prison, detention facility, or other facility in which persons are incarcerated.

“GUI” means graphical user interface.

“Having” means including but not limited to.

“Interface” means a portion of a computer processing system that serves as a point of interaction between or among two or more other components. An interface may be embodied in hardware, software, firmware, or a combination thereof.

“I/O device” may comprise any hardware that can be used to provide information to and/or receive information from a computer. Exemplary I/O devices may include disk drives, keyboards, video display screens, mouse pointers, joysticks, trackballs, printers, card readers, scanners (such as barcode, fingerprint, iris, QR code, and other types of scanners), RFID devices, tape drives, touch screens, cameras, movement sensors, network cards, storage devices, microphones, audio speakers, styli and transducers, and associated interfaces and drivers.

“Memory” may comprise any computer readable medium in which information can be temporarily or permanently stored and retrieved. Examples of memory include various types of RAM and ROM, such as SRAM, DRAM, Z-RAM, flash, optical disks, magnetic tape, punch cards, EEPROM, and combinations thereof. Memory may be virtualized, and may be provided in or across one or more devices and/or geographic locations, such as RAID technology, for example.

“Module” means a portion of a program.

“Network” may comprise a cellular network, the Internet, intranet, local area network (LAN), wide area network (WAN), Metropolitan Area Network (MAN), other types of area networks, cable television network, satellite network, telephone network, public networks, private networks, wired or wireless networks, virtual, switched, routed, fully connected, and any combination and subnetwork thereof. A network may use a variety of network devices, such as routers, bridges, switches, hubs, repeaters, converters, receivers, proxies, firewalls, translators and the like. Network connections may be wired or wireless, and may use multiplexers, network interface cards, modems, ISDN terminal adapters, line drivers, and the like. A network may comprise any suitable topology, such as point-to-point, bus, star, tree, mesh, ring, and any combination or hybrid thereof.

“Program” may comprise any sequence of instructions, such as an algorithm, for example, whether in a form that can be executed by a computer (object code), in a form that can be read by humans (source code), or otherwise. A program may comprise or call one or more data structures and variables. A program may be embodied in hardware, software, firmware, or a combination thereof. A program may be created using any suitable programming language, such as C, C++, Java, Perl, PHP, Ruby, SQL, other languages, and combinations thereof. Computer software may comprise one or more programs and related data. Examples of computer software may include system software (such as operating system software, device drivers and utilities), middleware (such as web servers, data access software and enterprise messaging software), application software (such as databases, video games and media players), firmware (such as software installed on calculators, keyboards and mobile phones), and programming tools (such as debuggers, compilers and text editors).

“Signal” means a detectable physical phenomenon that is capable of conveying information. A signal may include but is not limited to an electrical signal, an electromagnetic signal, an optical signal, an acoustic signal, or a combination thereof.

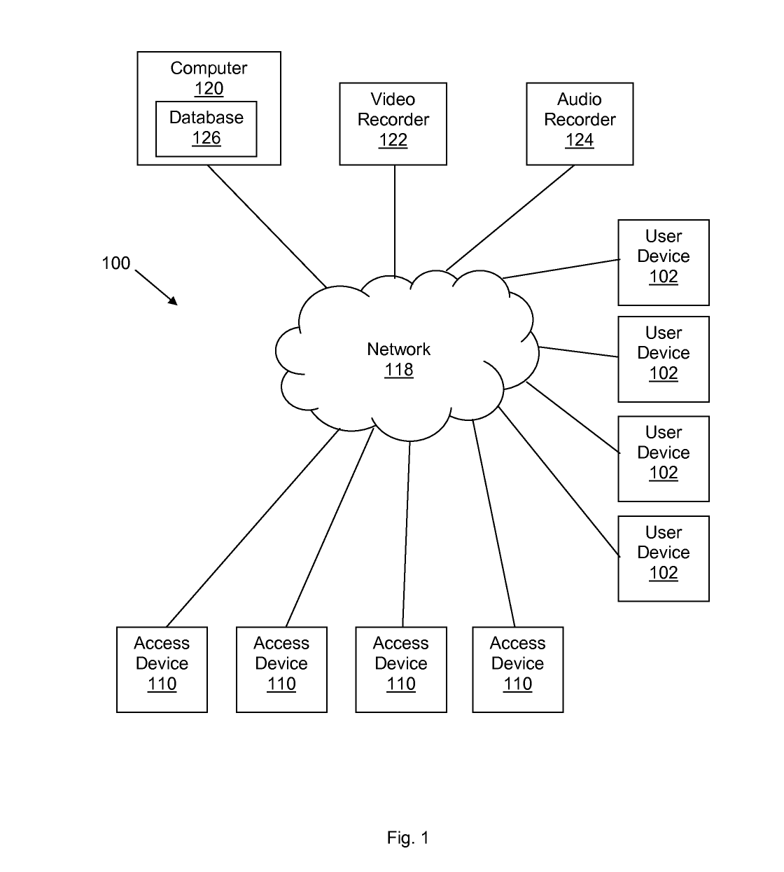

FIG. 1 shows a schematic diagram of a correctional facility access and security system 100. System 100 may include one or more user devices 102, one or more access devices 110, a network 118, a computer 120, a video recorder 122, and an audio recorder 124. Each of the user devices 102, access devices 110, computer 120, video recorder 122, and audio recorder 124 may comprise one or more computers programmed with one or more programs in one or more memories to carry out the methods described herein. Although four user devices 102 and four access devices 110 are shown in FIG. 1, system 100 may include any suitable number of user devices 102 and access devices 110. Each user device 102 and each access device 110 may be linked to network 118 by a wired connection, wireless connection, or some other suitable data communication means. In some embodiments, one or more access devices 110 may be linked to network 118 by a cat-5 Power Over Ethernet (POE) connection which provides power to the one or more access devices 110 and provides data communication between the one or more access devices 110 and network 118. Computer 120, video recorder 122 and audio recorder 124 may also be linked to network 118 by a wired connection, wireless connection or by some other data communication means.

Each component of system 100 may communicate with all of the other components of system 100 via network 118. Thus, access devices 110 may communicate with one or more of user devices 102 via network 118. In addition, access devices 110 may communicate with computer 120, video recorder 122 and audio recorder 124 via network 118. Similarly, user devices 102 may communicate with access devices 110, computer 120, video recorder 122 and audio recorder 124 via network 118. In some embodiments, communications between and among user devices 102, access devices 110, video recorder 122, and audio recorder 124 may be managed by computer 120, which may serve as a central communications hub. System 100 may include other components which may communicate with the components shown in FIG. 1 via network 118. Network 118 may be a local area network, a wireless or partially wireless local area network, the internet, or any other suitable network for sharing data between or among devices.

System 100 may be deployed in a correctional facility. In some embodiments, access devices 110 may be located near entry and exit points of the correctional facility, such as doors and gates, where entry and exit is to be monitored and controlled and activities in the vicinity are to be monitored. Access devices 110 may also be located near doors, gates and other entry and exit points that separate areas within the correctional facility, such as cell doors and doors between inmate housing and administrative offices.

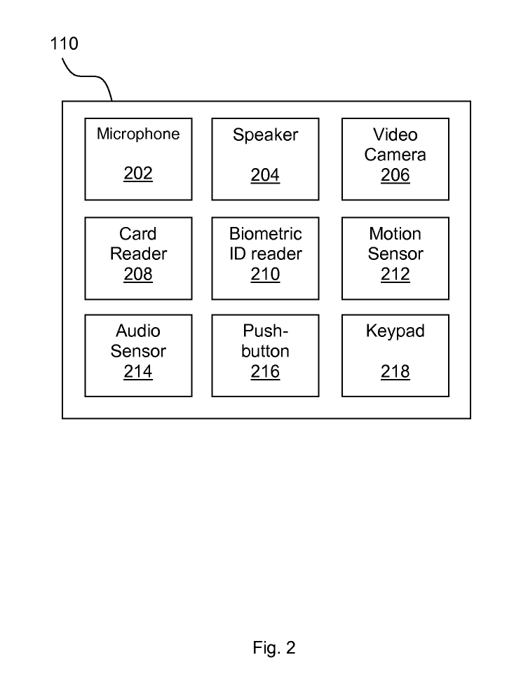

FIG. 2 shows a schematic diagram of an access device 110. As shown in FIG. 2, access devices 110 may include communication components, such as, for example, a microphone 202, a speaker 204, a video camera 206, and a pushbutton 216 or other suitable switch. In some embodiments, access device 110 may be linked to video recorder 122 and audio recorder 124 via network 118 such that video data collected by video camera 206 may be sent to video recorder 122 and audio data collected by microphone 202 may be sent to audio recorder 124. Access device 110 may also include user input components, such as, for example, a biometric ID reader 210, a pushbutton 216 and a keypad 218. Biometric ID reader 210 may read a biometric signature of a person at access device 110, such as a retina pattern or fingerprint of the person. Access device 110 may also include sensors, such as, for example, a motion sensor 212 and an audio sensor 214. Motion sensor 212 may sense a motion in the vicinity of access device 110, and audio sensor 214 may sense a sound in the vicinity of access device 110. Access devices 110 may also include various other computer components, such as a processor and memory.

Access device 110 may be ruggedized so as to be substantially tamper proof in the environment of a correctional facility. For example, in some embodiments, a face plate (not shown) of access device 110 may be made of about 11 gauge stainless steel. In addition, access device 110 may include a transparent cover (not shown), for example, a thick Plexiglas® cover, for a viewing zone of video camera 206 to protect a camera lens. Access device 110 may also have a baffle arrangement in which openings provided to facilitate sound transmission and reception via speaker 204 and microphone 202 are offset from each other to protect microphone 202, speaker 204 and other components from potential liquid damage. Access devices 110 may be embedded in walls of the correctional facility, and any wiring extending from access devices 110 may be routed through walls and other features of the correctional facility so that the wiring is not exposed and available for tampering. Other known tamper proofing mechanisms and means may be employed to secure access devices 110.

In some embodiments, access device 110 may include a video camera 206 which may provide video data to video recorder 122 and computer 120. Video camera 206 may provide real-time motion picture data to video recorder 122, for example in a H264, MJPG, MPEG-2, MPEG-4, or NTSC format, and may also provide still images to computer 120. In some embodiments, video camera 206 may include a wide-angle lens (not shown). The wide-angle lens may be oriented such that the expanded viewing dimension is substantially vertical rather than horizontal in order to better capture images of taller persons present in the vicinity of access device 110. In some embodiments, the wide-angle lens may be oriented such that the expanded viewing dimension is substantially horizontal in order to better capture the surroundings of access device 110. In some embodiments, the orientation of the wide-angle lens may be fixed upon installation of access device 110 or may be changeable by a user via a user device 102.

As described above, access devices 110 may also include a card reader 208, biometric ID reader 210, or other suitable data reading device that may read a card, biometric signature, or other identification source to verify the identity of a person present at access device 110. Access device 110 may also include a keypad 218 which allows a person present in the vicinity of access device 110 to enter data to access device 110. In addition, as described above, access devices 110 may include a pushbutton 216 for pressing by a person present in the vicinity of access device 110. Data received by access device 110 may be sent to one or more user devices 102 via network 118 and, thus, a user at user device 102 may monitor activity at access device 110. Data received by the access device 110 may also be sent to computer 120 via network 118 and may be stored in a memory storage device in computer 120, such as database 126.

Referring again to FIG. 1, system 100 may include computer 120. Computer 120 may be programmed with computer readable instructions for carrying out the methods described herein and may control communication between components of system 100 via network 118. Computer 120 may be linked to network 118 by a wired or wireless connection and may be mobile or stationary. As shown in FIG. 1, computer 120 may include a memory storage device, such as one or more databases 126. Computer 120 may also be linked via network 118 to an external memory storage device, such as cloud-based storage. In the embodiment shown in FIG. 1, computer 120, video recorder 122, and audio recorder 124 are shown as separate elements. In some embodiments, computer 120 may include video recorder 122, audio recorder 124 and other elements. For example, in one embodiment, computer 120 may include one or more user devices 102. Alternatively, computer 120, video recorder 122 and audio recorder 124 may be included within one or more user devices 102. In some embodiments, video recorder 122 and audio recorder 124 may communicate with computer 120 directly rather than via network 118.

System 100 may also include audio recorder 124. Audio recorder 124 may be any suitable audio recording software and hardware and may include, for example, ONEVOIP software and board by MCS. Audio recorder 124 may receive audio data from one or more user devices 102 and access devices 110. Microphones, such as microphones 202 and 302, may collect audio data at access devices 110 and user devices 102. Captured audio data may be digital or converted from analog data to digital data using suitable A/D conversion components, and access device 110 may send audio data to other components of system 100 via network 118.

System 100 may also include video recorder 122. Video recorder 122 may be any suitable video recording software and hardware and may be, for example, a network video recorder 122 (NVR). Video camera 206 may collect video data at access devices 110. Captured video data may be digital or converted from analog data to digital data using suitable A/D conversion components and may be sent from video recorder 122 to other components of system 100 via network 118. Although video recorder 122 and audio recorder 124 are shown as separate components in FIG. 1, video recorder 122 and audio recorder 124 may be combined in a single component which records video and audio simultaneously.

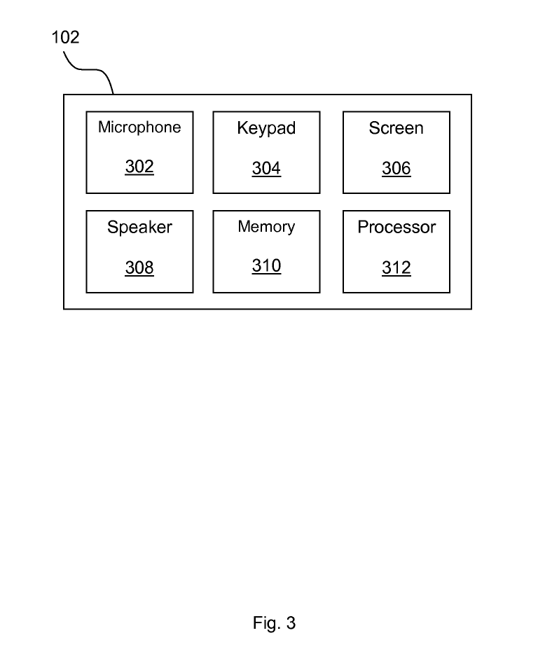

As shown in FIG. 1, system 100 may include one or more user devices 102. A schematic diagram of a user device 102 is shown in FIG. 3. User device 102 may be any suitable mobile or stationary device and may be in communication with access devices 110 and other components of system 100 via network 118. User devices 102 may be located with users who are qualified to allow people to enter and exit the correctional facility and areas within the correctional facility. Communication between user devices 102 and other devices (such as computer 120, access devices 110, video recorder 122 and audio recorder 124) via network 118 may be wired, wireless or a combination of wired and wireless communication, and such communication may be controlled by computer 120 via network 118. User device 102 may be any suitable computer device. User device 102 may be mobile to allow a user to carry user device 102 with the user, whether within the correctional facility or outside of the correctional facility. User devices 102 may also communicate with other user devices 102 via network 118. User device 102 may include microphone 302 for acquiring sound data from a user (such as a user's voice), data entry means (such as a keypad 304 or other suitable I/O device) for receiving input from a user, a screen 306 for displaying video data from access device 110, and a speaker 308 for playing audio data from access device 110. User devices 102 may also include various other computer components, such as a processor 312 and a memory 310.

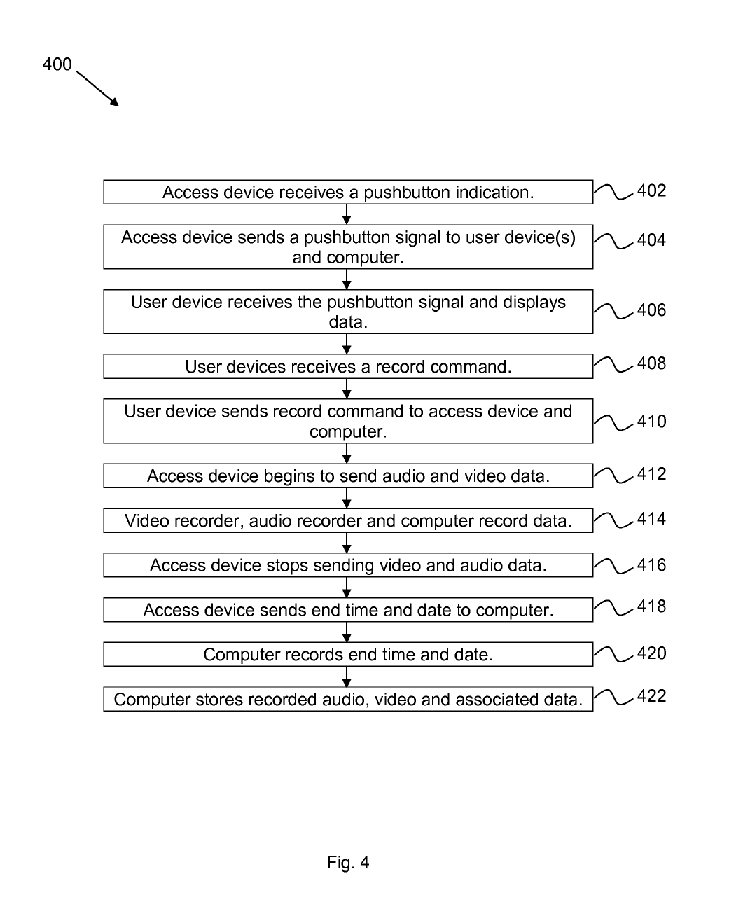

FIG. 4 shows a method 400 for securing and controlling access to a correctional facility using a system such as system 100. Pushbutton 216 of access device 110 (see FIG. 2) may be pressed by a person present at access device 110, and access device 110 may receive a pushbutton indication as shown at step 402. Access device 110 may send a pushbutton signal to one or more user devices 102 and/or computer 120 via network 118 (see FIG. 1) as shown at step 404. As shown at step 406, user device 102 may receive the pushbutton signal and display data associated with the pushbutton signal on screen 306 of user device 102 (see FIG. 3), such as a location of access device 110 within the correctional facility, for example. As shown at step 408, user device 102 may receive a record video command, a record audio command, or both from a user of user device 102. The record video command may indicate that access device 110 is to activate video camera 206, send video data to video recorder 122, and video recorder 122 is to begin recording video of the events and conditions present in the vicinity of the applicable access device 110 as captured by video camera 206. The record audio command may indicate that microphone 202 is to begin recording audio of sounds present in the vicinity of the applicable access device 110, that access device 110 is to send audio data to audio recorder 124, and that audio recorder 124 is to begin recording the audio data. As shown at step 410, user device 102 may send the record video command, record audio command, or both to the applicable access device 110 and/or computer 120 via network 118. As shown at step 412, upon receipt of the record video command, access device 110 may begin to send video data collected by video camera 206 to video recorder 122 via network 118, and upon receipt of the record audio command, access device 110 may begin to send audio data collected by microphone 202 to audio recorder 124 via network 118. As shown at step 414, video recorder 122 and audio recorder 124 may receive and record video and audio data, respectively, and computer 120 may record a date, time, associated user device 102, associated user, and associated access device 110 associated with the recorded video and audio. As shown at step 416, access device 110 may stop sending video data and audio data after a specified amount of time, when video recorder 122 and audio recorder 124 have not recorded any changed conditions for a specified amount of time, when access device 110 has opened or closed a corresponding door or gate, when access device 110 receives a stop command from a user device 102, or at the occurrence of some other event or condition. As shown at step 418, upon receipt of a stop command, or upon the occurrence of another event which stops the sending of video and/or audio data, access device 110 may send an end time and date to computer 120 to be associated with the recorded audio and video. As shown at step 420, computer 120 may record the end time and date associated with the end of the received audio and video data. As shown at step 422, computer 120 may store recorded video, audio and associated data (e.g., time, date, associated access device 110, associated user device 102, associated user, and the like) in a memory storage device, such as database 126. Database 126 may be searchable and may allow a user to search audio and video recordings by time, date, associated access device 110, associated user device 102, associated user, other data associated with such recordings, or a combination thereof. In some embodiments, database 126 may be searched from computer 120, or user devices 102, or other remote computers via network 118. Stored audio and video files responsive to the search criteria may be selected and played back on user devices 102, computer 120, or other remote computers.

Although the embodiment of FIG. 4 describes the pushing of a pushbutton 216, method 400 may begin with the receipt of other input, such as, for example, sensing a sound or motion or receiving input from a biometric signature, user ID card, or other identification source. For example, in some embodiments, audio sensor 214 may sense a sound in the vicinity of access device 110. Access device 110 may send a sound detected signal to one or more user devices 102 via network 118 when audio sensor 214 senses a sound in the vicinity of access device 110. A user at a user device 102 may then be alerted that a sound has been sensed in the vicinity of access device 110 and may have the opportunity to begin sound and/or video recording and data transmission operations at that access device 110, as described above. In some embodiments, motion sensor 212 may sense a motion in the vicinity of access device 110. Access device 110 may send a motion detected signal to one or more user devices 102 and computer 120 via network 118. A user at user device 102 may be alerted that a motion has been sensed in the vicinity of access device 110 and may then have the opportunity to begin sound and/or video recording and data transmission operations at that access device 110. In some embodiments, access device 110 may send a signal to user devices 102 when some other device, such as biometric ID reader 210, card reader 208, or other data reading device, reads a biometric signature, card, or other identification source, respectively. The user at user device 102 may then be alerted of the read data and have the opportunity to begin audio and/or video recording and data transmission operations, as described above.

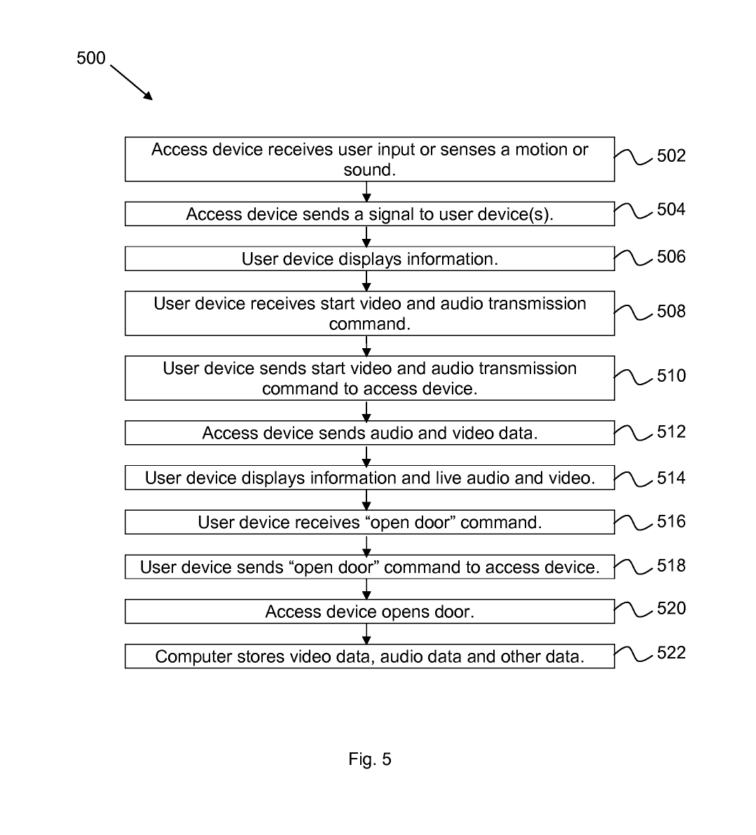

As stated above, each access device 110 may be associated with an access or exit point, such as a door or gate, which allows entry and/or exit to the correctional facility or areas within the correctional facility. As shown at step 502 of method 500 in FIG. 5 and as described above, access device 110 may receive a user input or may sense a motion or sound in the vicinity of access device 110. As discussed above, user input may include pressing a pushbutton 216, sensing a card at a card reader 208, sensing a biometric ID at a biometric ID reader 210, or reading data at a data reading device. In addition, method 500 may begin when motion sensor 212 senses a motion in the vicinity of access device 110 or audio sensor 214 senses a sound in the vicinity of access device 110. As shown at step 504, access device 110 may send a signal to one or more user devices 102. As shown at step 506, user devices 102 may display information concerning the input received at access device 110, such as a name and access permissions associated with a card read by card reader 208. As shown at step 508, user device 102 may receive a start video and audio transmission command from a user when a user of user device 102 enters data into user device 102, using keypad 304, for example, and user device 102 may send a start video and audio transmission command to access device 110 as shown at step 510. As shown at step 512, access device 110 may send audio and video data to audio recorder 124, video recorder 122, and user device 102. As shown at step 514, user device 102 may display information concerning the input received at access device 110 and may display live audio and video data received from access device 110 via network 118.

Still referring to FIG. 5, a user of user device 102 may decide to allow entry or exit through the entry or exit point associated with access device 110 to the person at access device 110. As such, the user may enter that command into user device 102. As shown at step 516, user device 102 may receive an “open door” command from the user of user device 102. Such a command may be, for example, a voice command received by a microphone 202 in user device 102 and processed by processor 312, a button or other switch pressed by a user of user device 102, an option selected on a touch screen or other GUI in user device 102, a keypad command entered on keypad 218, or any other method of receiving input to user device 102 via a suitable I/O device. As shown at step 518, user device 102 may then send an “open door” command to access device 110 via network 118. As shown at step 520, access device 110 may open a corresponding door or gate in response to the “open door” command to allow the person at access device 110 to enter or exit the secured facility or an area within the secured facility. As shown at step 522, computer 120 may store data associated with the preceding steps, such as a date and time associated with receipt of input at access device 110; date, time, user device ID and user ID associated with receipt of user input at user device 102; and date, time, and access device ID associated with opening a door associated with access device 110. Such data may be stored in a memory storage device, such as database 126, and may be searchable, for example, by a user at computer 120 or at a user device 102. Computer 120 may also store recorded video and audio data.

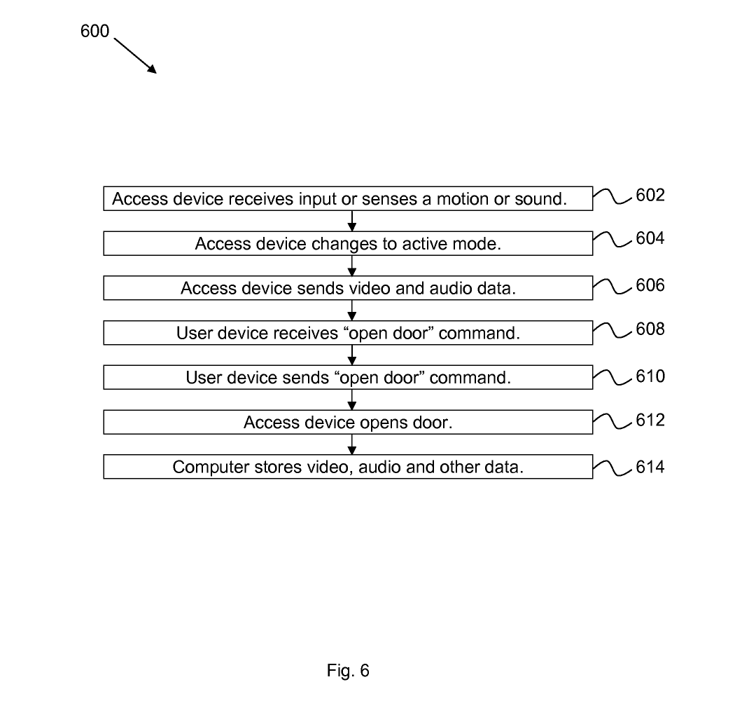

FIG. 6 shows a method 600 for controlling and monitoring a correctional facility. As shown in FIG. 6, access device 110 may receive input from a person in the vicinity of access device 110 or may sense a sound or motion in the vicinity of access device 110, as shown at step 602 and discussed above. A default mode of access device 110 may be a “sleep mode,” in which neither video nor audio data is sent to video recorder 122 and audio recorder 124, respectively, unless and until access device 110 becomes active. Upon receipt of input from a person at access device 110 or sensing a sound or motion at access device 110, access device 110 may automatically change from “sleep mode” to an active mode (as shown at step 604) in which access device 110 may automatically begin to send video and audio data to video recorder 122 and audio recorder 124, respectively, via network 118 as shown at step 606. Access device 110 may also automatically begin to send video and audio data to one or more user devices 102. Access device 110 may also begin to send data to computer 120, such as a time and date associated with receiving input from a person in the vicinity of access device 110 or sensing a sound or motion at access device 110. In some embodiments, user device 102 may include one or more speakers 308 and a screen 306 capable of playing audio data and showing video data, respectively, received from access device 110. As such, a user of user device 102 may be able to view the person in the vicinity of access device 110 and may be able to hear sounds in the vicinity of access device 110, such as, for example, words spoken by the person in the vicinity of access device 110. In some embodiments, user device 102 may include a microphone 302, and user device 102 may send audio data picked up by microphone 302 to access device 110 and audio recorder 124 via network 118. In some embodiments, a person at access device 110 may be able to hear and converse with a user at user device 102 but will not be able to see the user of user device 102. The user at user device 102 may be able to hear, converse with and see a person at access device 110 due to video data visible on screen 306 of user device 102 and audio data played by speaker 308. Thus, audio communication between user device 102 and access device 110 may be two-way such that a person present at access device 110 and a remote user at user device 102 may audibly communicate with each other.

As discussed above, and still referring to FIG. 6, user device 102 may receive an “open door” command from the user as shown at step 608 and may send an “open door” signal to access device 110 as shown at step 610. As shown at step 612, in response to the “open door” signal, access device 110 may open a door or other entry or exit point associated with access device 110. Further, a user may enter a “close door” command to user device 102. In turn, user device 102 may send a “close door” signal to access device 110 via network 118, and access device 110 may close a door associated with access device 110 or may insure that such a door is already closed. As shown at step 614, computer 120 may store data associated with the preceding steps, such as a date and time associated with receipt of user input at access device 110; date, time, and userID associated with receipt of user input at user device 102; and date, time, and access device ID associated with opening or closing a door associated with access device 110. Such data may be stored in a memory storage device, such as database 126, and may be searchable, for example, by a user at computer 120 or a user at user device 102.

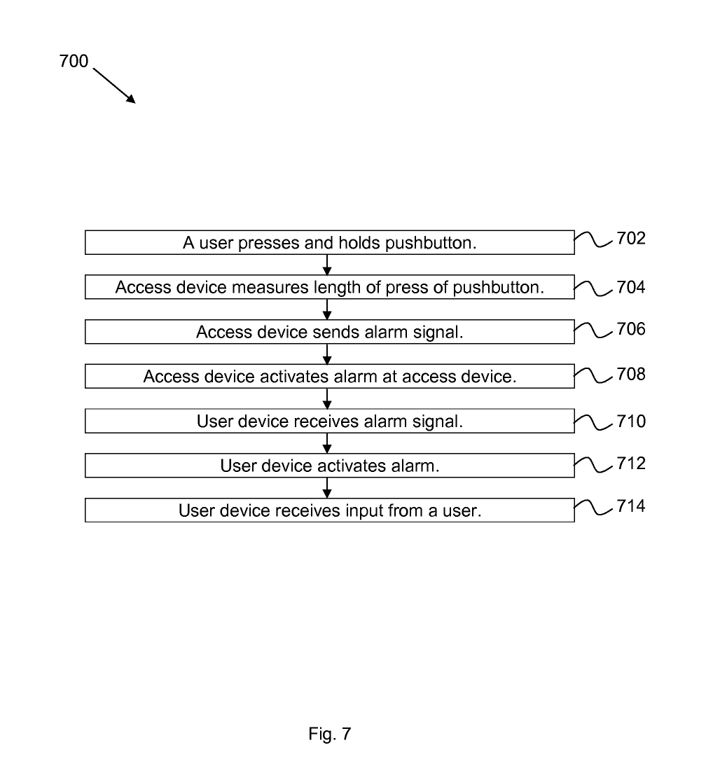

FIG. 7 shows another method 700 for securing and controlling access to a correctional facility. As shown in FIG. 7, a person may press and hold pushbutton 216 of access device 110 as shown at step 702. As shown at step 704, access device 110 may measure the length of time pushbutton 216 is pressed by the person. If the length of time pushbutton 216 is pressed and held exceeds a predetermined time, access device 110 may send an alarm signal to one or more user devices 102 as shown at step 706 and/or may activate an alarm at access device 110 as shown at step 708. The alarm at access device 110 may include a visual alarm, an auditory alarm or both. As shown at step 710, user device 102 may receive the alarm signal and in response may activate a visual alarm, an auditory alarm, or both at user device 102 as shown at step 712. In some embodiments, access device 110 may automatically begin to send audio and video data to user device 102 and/or video recorder 122 and audio recorder 124 if the length of time that pushbutton 216 is pressed exceeds a predetermined time. User device 102 may display the audio and video data using one or more speakers 308 and video screen 306, respectively. As shown at step 714, user device 102 may receive input from a user indicating that the alarm is to be terminated, may receive input from a user indicating that the alarm is to be forwarded to other user devices 102 or other communication devices, such as telephone systems at security or police stations, or may receive some other command from the user.

As discussed above, recordings of audio and video may begin at specified events or commands and may end at specified events or commands. Thus, “a recording” of sound or video may have a beginning and an end, and each “recording” may be a separate file stored in a memory storage device, such as database 126. Each separate recording of audio and video by audio recorder 124 and video recorder 122, respectively, may be associated with a date, time and access device ID associated with the applicable access device 110. In addition, if a user device 102 sent or received data during the recording of the video, audio or both, a user device ID and user ID may be associated with each separate recording of audio and video. Audio and video recordings may also be associated with each other so that audio recordings match video recordings which were recorded simultaneously for a particular access device 110. In some embodiments, video recorder 122 and audio recorder 124 may be combined, and sound and video may be recorded as a single file by the combined video recorder 122 and audio recorder 124.

As discussed above, data and files associated with recorded audio and video, and data associated with such data and files, such as user ID and access device ID, may be stored in a memory storage device, and may be searchable according to date, time, access device ID, user ID, user device ID, or other parameters. Thus, a user may search for and identify data associated with a particular sound recording or audio recording, or may search for and identify a sound recording or video recording associated with one or more dates, times, access device IDs, user IDs, user device IDs, or other parameters. For example, upon the occurrence of a security breach, security officials may desire to search for and review all video and audio recordings taken for a specific access device 110 during a specified period of time. Security officials may also desire to search for all users of user devices 102 involved in allowing people to pass through a door or denying passage through a door during the specified period of time. By searching the memory storage device, the officials may obtain such data and review audio and video recordings associated with such data.

The embodiments described above are some examples of the current invention. Various modifications and changes of the current invention will be apparent to persons of ordinary skill in the art. Among other things, any feature described for one embodiment may be used in any other embodiment, and methods described and shown in the figures may be combined. In addition, the order of steps shown in the figures and described above may be changed in different embodiments. The scope of the invention is defined by the claims that may be drawn to this invention, considering the doctrine of equivalents, and is not limited to the specific examples described herein.

What is claimed is:

1. A correctional facility access and security system comprising:
one or more access devices each comprising a first microphone, a first speaker, and a video camera and each being installed proximate to a respective access point of the correctional facility and configured such that said first microphone is adapted to collect first audio data from a vicinity of said access point, said video camera is adapted to collect video data from said vicinity, and said first speaker is adapted to play second audio data;
one or more user devices in communication with said one or more access devices via a network, wherein each of said one or more user devices comprises a video screen adapted to display said video data, a second speaker adapted to play said first audio data, and a second microphone adapted to collect said second audio data;
a computer configured to facilitate said communication via said network such that said first audio data and said video data are communicated to at least one of said one or more user devices, and such that said second audio data is communicated to at least one of said one or more access devices;
a video recorder configured to receive and record said video data; and
an audio recorder configured to receive and record said first and second audio data;
wherein said computer is configured to store other data associated with at least one of said video data, said first audio data, and said second audio data in a memory, said other data being searchable by one or more user selected criteria.

2. The system of claim 1 wherein said other data is selected from time, date, associated access device, associated user device, associated user, and combinations thereof.

3. The system of claim 1 wherein at least one of said one or more access devices comprises a sensor selected from a motion sensor, an audio sensor, and a combination thereof.

4. The system of claim 3 wherein said at least one of said one or more access devices is configured to change from a sleep mode to an active mode upon said sensor sensing a motion or sound, wherein in said sleep mode neither said video data nor said first audio data is sent to said video recorder or said audio recorder, respectively, and wherein in said active mode said video data and said first audio data are automatically sent to said video recorder and said audio recorder, respectively.

5. The system of claim 4 wherein in said active mode said video data and said first audio data are automatically sent to at least one of said one or more user devices.

6. The system of claim 3 wherein, upon said sensor sensing a sound or motion, said at least one of said one or more access devices is configured to send a sound detected signal or a motion detected signal, respectively, to at least one of said one or more user devices.

7. The system of claim 6 wherein said at least one of said one or more user devices is configured to send a record video command, a record audio command, or both a record video command and a record audio command to said at least one of said one or more access devices, and wherein said at least one of said one or more access devices is configured to send said video data, said first audio data, or both said video data and said first audio data to said video recorder and said audio recorder, respectively, upon receipt of respective ones of said commands.

8. The system of claim 1 wherein said computer, said video recorder, and said audio recorder are included in one of said user devices.

9. The system of claim 1 wherein said video recorder and said audio recorder are included in the same device.

10. The system of claim 1 wherein at least one of said one or more access devices comprises a pushbutton, and wherein said at least one of said one or more access devices is configured to send a pushbutton signal to at least one of said one or more user devices.

11. The system of claim 10 wherein said at least one of said one or more user devices is configured to display data associated with said pushbutton signal including a location of said at least one of said one or more access devices within said correctional facility.

12. The system of claim 11 wherein said at least one of said one or more user devices is configured to send a record video command, a record audio command, or both a record video command and a record audio command to said at least one of said one or more access devices, and wherein said at least one of said one or more access devices is configured to send said video data, said first audio data, or both said video data and said first audio data to said video recorder and said audio recorder, respectively, upon receipt of respective ones of said commands.

13. A correctional facility access and security apparatus comprising:
an access device comprising a pushbutton, a microphone, a speaker, and a video camera, wherein said access device is configured to communicate via a network with a user device, a computer, a video recorder, and an audio recorder;
wherein, upon said pushbutton being pressed, said access device is configured to send a pushbutton signal to said user device;
wherein, upon receipt of a record signal from said user device, said access device is configured to begin sending video data collected by said video camera and audio data collected by said microphone to said video recorder and said audio recorder, respectively, and to said user device via said network;
wherein, upon said pushbutton being pressed for a predetermined period of time, said access device is configured to send an alarm signal to said user device; and
wherein, upon receipt of an open signal from said user device, said access device is configured to open a door or gate associated with said access device.

14. The apparatus of claim 13 further comprising a sensor selected from a motion sensor, an audio sensor, and a combination thereof, wherein said access device is configured to send a motion detected signal, a sound detected signal, or both, respectively, to said user device upon sensing a motion, a sound, or both, respectively.

15. The apparatus of claim 13 wherein said access device is embedded in a wall and comprises a ruggedized structure having a stainless steel faceplate, a transparent cover over a viewing zone of said video camera, and a baffle arrangement in which openings provided to facilitate sound transmission and reception via said speaker and said microphone are offset from each other to protect said speaker and said microphone.

16. The apparatus of claim 13 wherein said video camera comprises a wide-angle lens oriented such that an expanded viewing dimension is substantially vertical.

17. The apparatus of claim 13 further comprising an identification device selected from a card reader, a biometric reader, and a combination thereof.

18. A correctional facility access and security method comprising:
receiving an input signal at an access device associated with an access point of the correctional facility, said input signal comprising a pushbutton signal, a user identification signal, or a motion or audio sensor signal;
sending an alert signal to a user device in response to said input signal;
receiving a record command from said user device;
recording video data, audio data, or both video data and audio data from a vicinity of said access device in response to said record command;
receiving a start transmission command from said user device;
sending said video data, said audio data, or both said video data and said audio data to said user device in response to said start transmission command;
receiving an open command from said user device;
opening said access point in response to said open command;
receiving a close command from said user device; and
closing said access point in response to said close command.

19. The method of claim 18 further comprising stopping said recording upon an occurrence of any one of the following:
a lack of a change in conditions at said vicinity for a specified amount of time;
upon said closing of said access point; or
upon receipt of a stop recording command.

20. The method of claim 18 further comprising:
measuring a duration of said pushbutton signal;
sending an alarm signal to said user device if said duration exceeds a predetermined length of time; and
activating an alarm at said access device if said duration exceeds a predetermined length of time.
